(19) United States
(12) Patent Application Publication
(10) Pub. No.: US 2008/0164665 A1
(43) Pub. Date: Jul. 10, 2008

(54) Stair-climbing vehicle

(75) Inventor: Hsueh-Er Chang, Taipei City (TW)

Correspondence Address: TROXELL LAW OFFICE PLLC;SUITE 1404, 5205 LEESBURG PIKE, FALLS CHURCH, VA, 22041, US

(73) Assignee: HSUEH-ER CHANG, Taipei City (TW)

(21) Appl. No.: 11/649,894

(22) Filed: Jan. 5, 2007

(51) Int. Cl. B62B 5/02

(52) U.S. Cl. 280/5.28

(57) ABSTRACT

A vehicle for carrying object can overcome stairs and special geography. Rotators having wheels with of without auxiliary wheel are used. Various combinations of rotators and auxiliary wheel are possible.

### FIELD OF THE INVENTION

The present invention relates to a vehicle; more particularly, relates to pulling a carrier to climb up stairs or overcome specific geography.

### DESCRIPTION OF THE RELATED ART

A prior art has a box; the box has a vertical seat extended upward a long two sides at the back; the seat has wheel sets having wheels; and, diameters of the wheels are gradually extended top-downwardly, where, that is to say, at the back of the box, the upper wheel has a bigger diameter than the lower one. With the above structure, on going upstairs, the wheels are butted against a vertical surface of a stair. When keeping on pulling the box in a slanted way, the upper wheel is butted against a horizontal surface of the stair and the lower wheel is butted against the vertical surface of the stair Thus, the box can be pulled up stairs.

Although the above prior art has the wheels butted against a vertical surface of a stair, the upper wheel butted against a horizontal surface of the stair, and the lower wheel butted against a vertical surface of the stair, so as to make the box be pulled up stairs, the box has to be pulled in a certain angle to butt the wheels against the surfaces of the stair. If the box is pulled straight vertically or in other angle, the box is stuck or hard to be pulled. Hence, the prior art does not fulfill users' requests on actual use.

### SUMMARY OF THE INVENTION

The main purpose of the present invention is to pull a carrier to climb up stairs or overcome specific geography.

To achieve the above purpose, the present invention is a stair climbing vehicle and a first preferred embodiment comprises a carrier; a shaft being fixed at bottom of the carrier; two transverses being separately and movably set at two sides of the shaft; two first rotators being separately and movably set at ends in a direction of the transverses and each having five juts for being separately and movably equipped with five wheels; two second rotators being separately and movably set between ends in two directions of the transverses and each having five juts for being separately and movably equipped with five wheels; and two auxiliary wheels being separately and movably set at ends in another direction of the transverses.

A second preferred embodiment comprises a carrier; two first rotators being separately and movably set at two sides below the carrier and each having five juts for being separately and movably equipped with five wheels; two second rotators being separately and movably set at two sides below the first rotators and each having five juts for being separately and movably equipped with five wheels; and two auxiliary wheels being separately and movably set at two sides below the second rotators.

A third preferred embodiment comprises a carrier; two transverses being separately and movably set at two sides below the carrier; two first rotators being separately and movably set at ends in a direction of the transverses and each having five juts for being separately and movably equipped with five wheels; two second rotators being separately and movably set at ends in another direction of the transverses and each having five juts for being separately and movably equipped with five wheels; and two third rotators being separately and movably set at two sides below the second rotators and having five juts for being separately and movably equipped with five wheels.

Accordingly, a novel stair-climbing vehicle is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is the perspective view showing the first preferred embodiment according to the present invention;

FIG. 2 is the explosive view showing the first preferred embodiment;

FIG. 3 is the view showing the first state of use of the first preferred embodiment;

FIG. 4 is the view showing the second state of use of the first preferred embodiment;

FIG. 5 is the perspective view showing the second preferred embodiment;

FIG. 6 is the explosive view showing the second preferred embodiment; and

FIG. 7 is the perspective view showing the third preferred embodiment.

### DESCRIPTIONS OF THE PREFERRED EMBODIMENTS

The following descriptions of the preferred embodiments are provided to understand the features and the structures of the present invention.

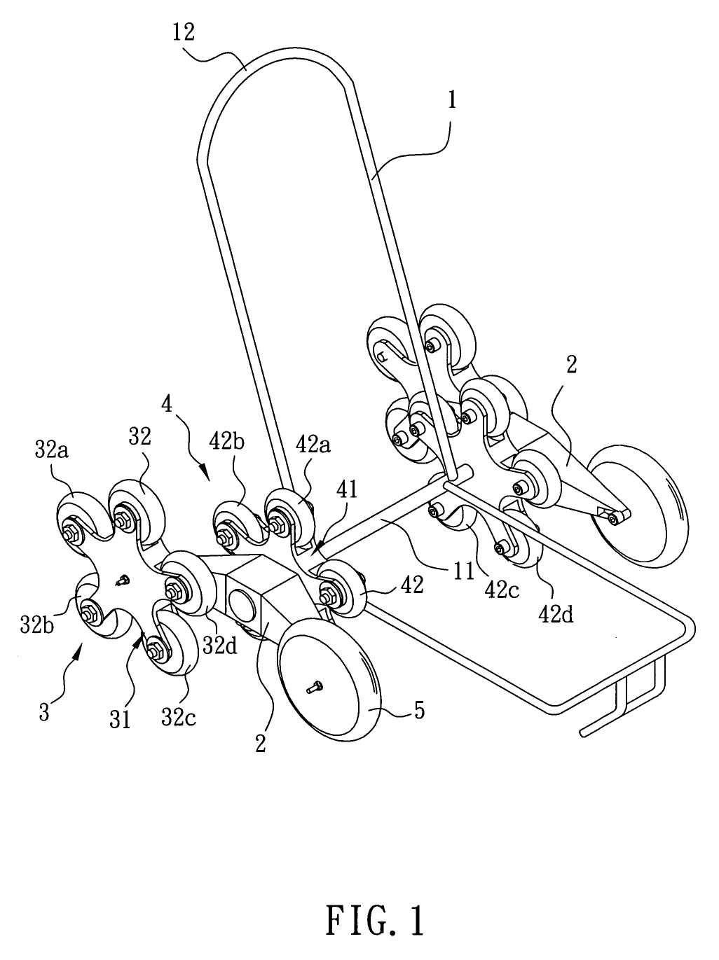

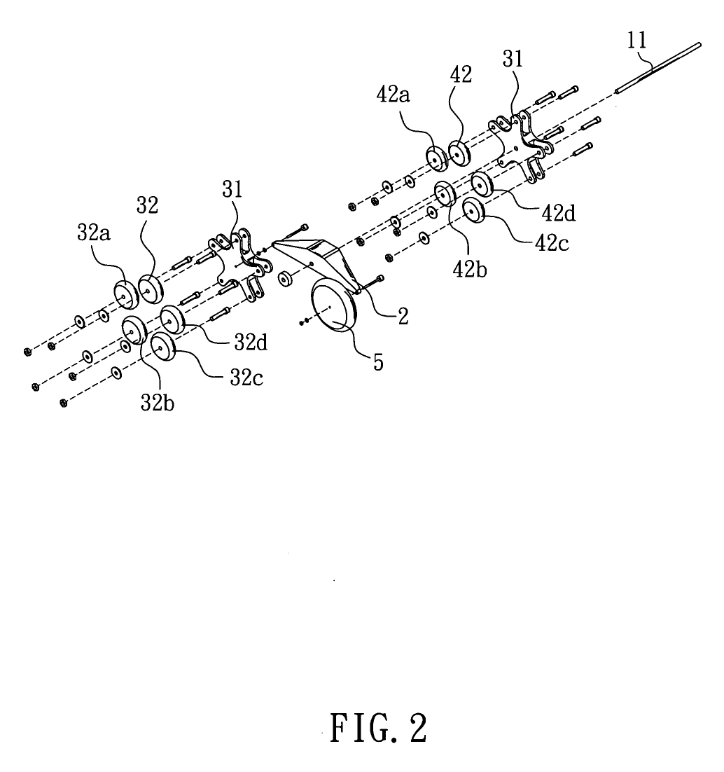

Please refer to FIG. 1 and FIG. 2 which are a perspective view and an explosive view showing a first preferred embodiment according to the present invention. As shown in the figures, the present invention is a stair-climbing vehicle, comprising a carrier 1, a shaft 11, two transverses 2, two first rotators 3, two second rotators 4 and two auxiliary wheel 5, where the carrier 1 is pulled to climb up stairs or overcome specific geography through the first rotators 3 and the second rotators 4.

The carrier 1 is a property for carrying objects, like a basket, a box or a wheelchair. The shaft 11 connects the two transverses 2 at bottom of the carrier 1 and is located around the middle of the transverse 2.

The transverses 2 are separately set at two sides of the shaft 11.

The first rotators 3 are separately and movably set at ends in a direction of the transverses 2; and each of the first rotator 3 has five juts 31 to be set with five wheels 32, 32a, 32b, 32c, 32d separately.

The second rotators 4 are separately and movably set between two ends of the transverses 2 near where the shaft 11 are connected with; and each of the second rotator 4 has five juts 31 to be set with five wheels 32, 32a, 32b, 32c, 32d separately.

The auxiliary wheels 5 are movably set at ends in another direction of the transverses 2: Thus, a novel stair-climbing vehicle is obtained.

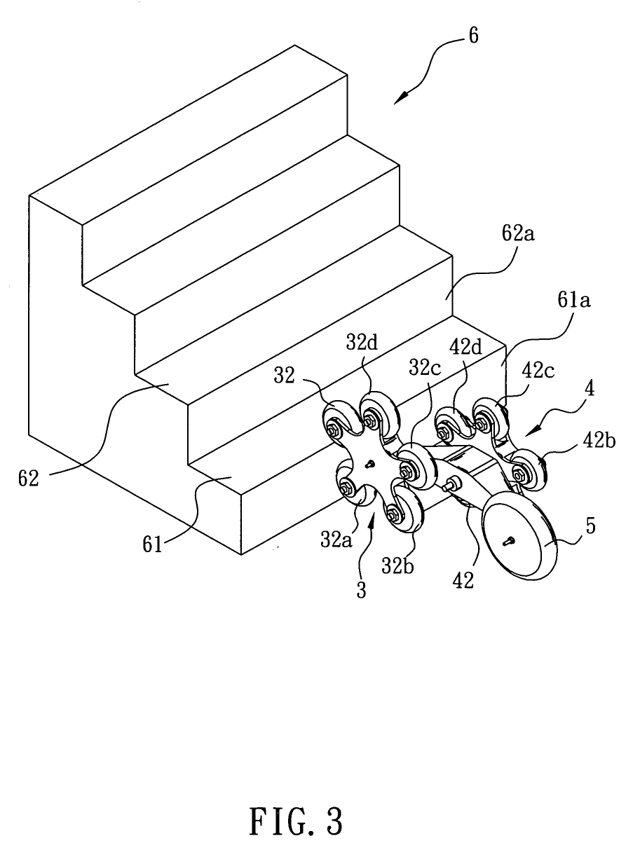

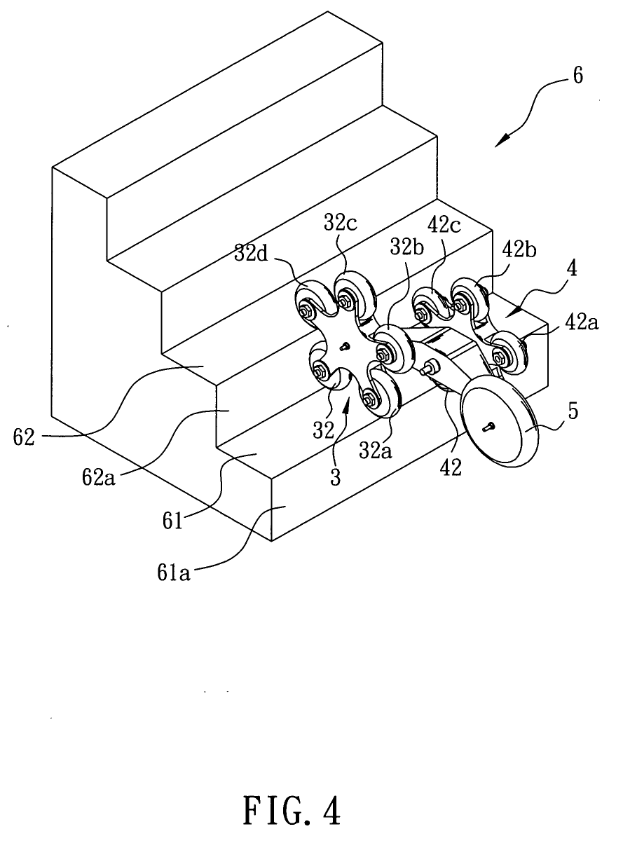

Please refer to FIG. 3 and FIG. 4, which are a view showing the first and the second states of use of the first preferred embodiment. As shown in the figures, when using the present invention, a handle 12 at an end of a carrier 1 is pulled to carry the carrier 1. When moving on the ground, wheels 42, 42a of two second rotators 4 are rolling on the ground. When starting to climbing up, two wheels 32 of two first rotators 3 are butted against a first horizontal surface 61 of the stair 6 and another two wheels 32a of two first rotators 3 are butted against a first vertical surface 61a of the stair 6. At the moment, two auxiliary wheels 5 are laid on the ground so that the second rotators 4 are not in touch with the stair 6 and the ground. Then, when keeping on climbing up, the wheels 21, 32a of the first rotators 3 are rolled to be butted against the first horizontal surface 61, during which wheels 42d, 42 of the second rotators 4 are butted against the first horizontal surface 61 and the first vertical surface 61a; and the auxiliary wheels 5 are hanged with out function. And then, when continuing climbing up, following the above steps, the first rotators 3 are butted against a second horizontal surface 62 and a second vertical surface of a stair above; the auxiliary wheels 5 are butted against the first horizontal surface 61; and the second rotators 4 are hanged again without in touch with any surface. Thus, through the reciprocation of the first rotators 3, the second rotators 4 and the auxiliary wheels 5, the carrier 1 climbs up stairs.

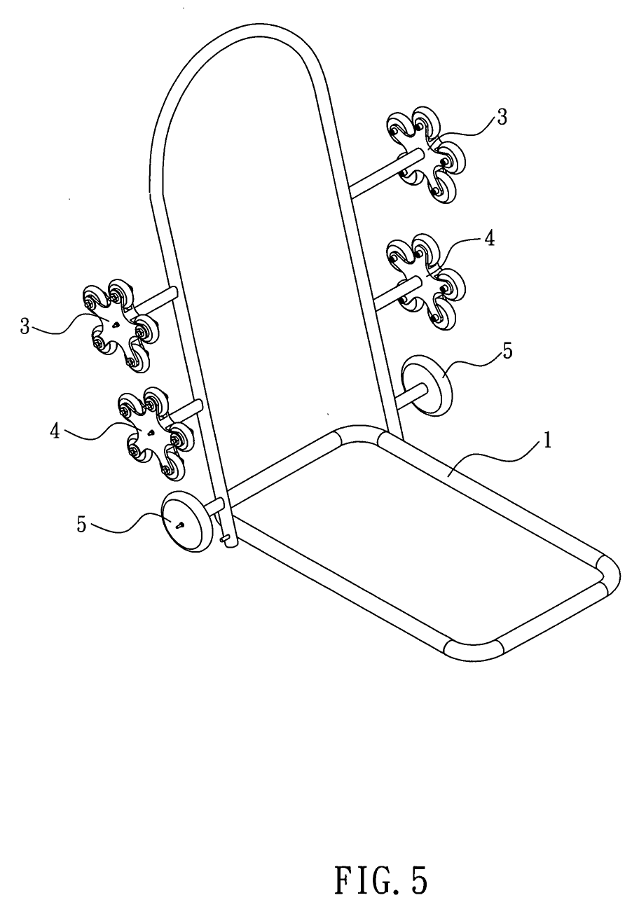

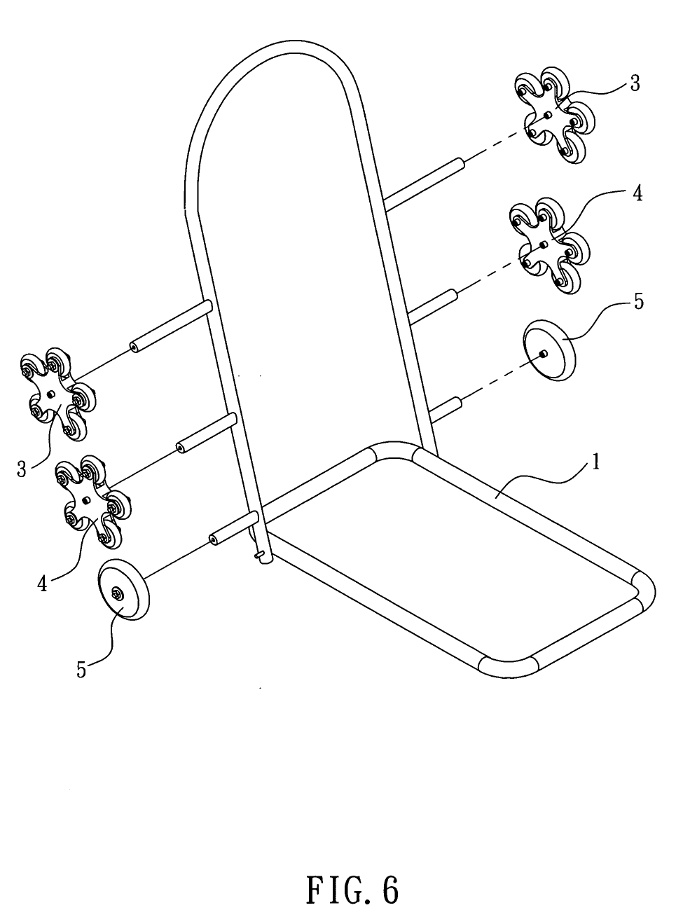

Please refer to FIG. 5 and FIG. 6, which are a perspective view and an explosive view showing a second preferred embodiment. As shown in the figures, from top to bottom, the first rotators 3, the second rotators 4 and the auxiliary wheels 5 are separately set at two sides at bottom of the carrier 1. And, through the reciprocation of the first rotators 3, the second rotators 4 and the auxiliary wheels 5, the carrier 1 climbs up stairs.

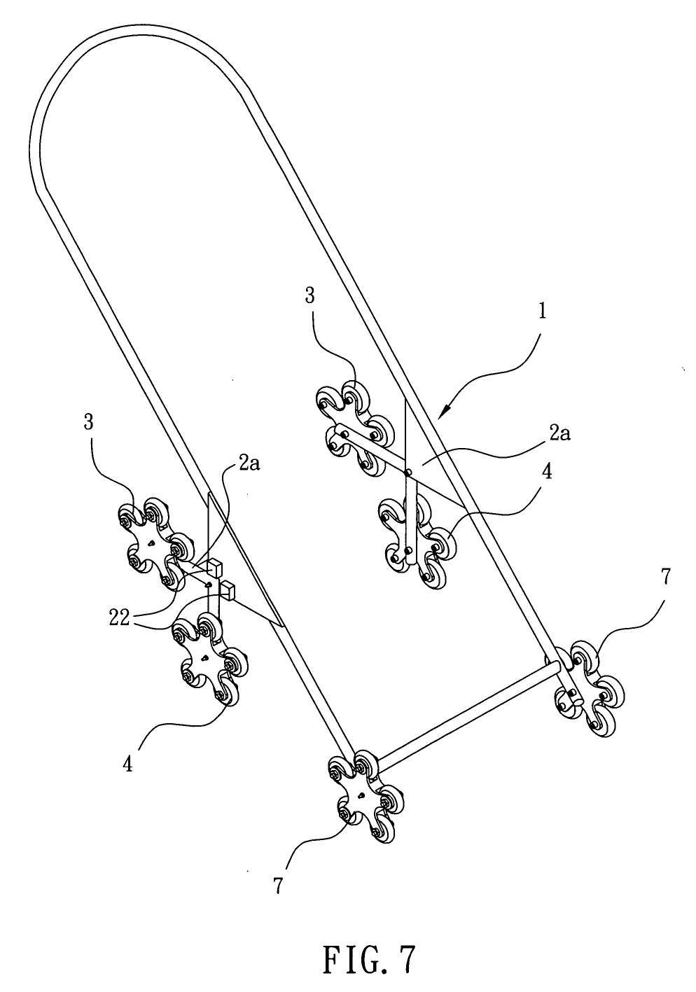

Please refer to FIG. 7, which is a perspective view showing a third preferred embodiment. As shown in the figure, two ‘L’-shaped transverses 2a are separately set at two sides at bottom of the carrier 1, where a first rotator 3 and a second rotators 4 are separately set at two ends of each transverse 2a. And two third rotators 7 are set below the transverses 2a. In addition, stoppers 22 are set to limit a turning angle of the transverses 2a.

In the above preferred embodiments, a rotator having five wheels are used for climbing up stairs. However, the wheels can be more than five or fewer then five; the auxiliary wheel can be a rotator having wheels; and the combination of three rotators and the combination of two rotators and an auxiliary wheel can be replaced with a combination of more than three components of rotators with or without auxiliary wheel. Besides, a shaft can be located at ends in a direction of transverses where first rotators are set; or, the shaft can be located at ends in another direction of the transverses where auxiliary wheels are set.

To sum up, the present invention is a stair-climbing vehicle, where a carrier is pulled to climb up stairs or overcome specific geography.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A stair-climbing vehicle, comprising:
a carrier;
a shaft, said shaft being fixed at bottom of said carrier;
two transverses, said transverses being separately and movably deposed at two ends of said shaft;
two first rotators, each said first rotator being separately and movably deposed at an end of said transverse, said first rotator having five juts to be separately deposed with five wheels;
two second rotators, each said second rotator being separately and movably deposed between two ends of said transverse, said second rotator having five juts to be separately deposed with five wheels
two auxiliary wheels, each said auxiliary wheel being separately and movably deposed at another end of said transverse.

2. The vehicle according to claim 1,
wherein said carrier is a property carrying objects; and
wherein said property is selected from a group consisting of a basket, a box and a wheelchair.

3. The vehicle according to claim 1,
wherein said shaft is movably located at an end of said transverse; and
wherein said end of said transverse is deposed with said first rotator.

4. The vehicle according to claim 1
wherein said shaft is movably located at an end of said transverse; and
wherein s aid end of said transverse is deposed with said auxiliary wheel.

5. The vehicle according to claim 1,
wherein said shaft is movably located between two ends of said transverse.

6. A stair-climbing vehicle, comprising: a carrier;
two first rotators, each said first rotator being separately deposed in a direction at two sides of said carrier, said first rotator having five juts to be separately deposed with five wheels;
two second rotators, said second rotators being separately deposed in said direction of said first rotators at two sides of said carrier, said second rotator having five juts to be separately deposed with five wheels; and
two auxiliary wheel, said auxiliary wheel being separately deposed in said direction of said second rotators at two sides of said carrier.

7. The vehicle according to claim 6, wherein said carrier is a property carrying objects; and
wherein said property is selected from a group consisting of a basket, a box and a wheelchair.

8. A stair-climbing vehicle, comprising
a carrier;
a shaft, said shaft being fixed at two sides at bottom of said carrier;
two transverses, said transverses being separately deposed at two sides in a direction of said carrier;
two first rotators, said first rotator being separately deposed at an end of said transverse, said first rotator having five juts to be separately deposed with five wheels
two second rotators, said second rotator being separately deposed at another end of said transverse, said second rotator having five juts to be separately deposed with five wheels; and
two third rotators, said third rotator being separately deposed in said direction on said transverse, said third rotator having five juts to be separately deposed with five wheels.

9. The vehicle according to claim 8,
wherein said carrier is a property carrying objects; and
wherein said property is selected from a group consisting of a basket, a box and a wheelchair.

10. The vehicle according to claim 8, wherein said transverse is ‘L’-shaped.

11. The vehicle according to claim 8, wherein said vehicle has a stopper limiting a turning angle of said transverse.
